(19) United States
(12) Patent Application Publication
(10) Pub. No.: US 2023/0317390 A1
(43) Pub. Date: Oct. 5, 2023

(54) Safety Shut-Off Relay

(71) Applicant: Jacob Trent Hearnsberger, Springhill, LA (US)

(72) Inventor: Jacob Trent Hearnsberger, Springhill, LA (US)

(21) Appl. No.: 17/711,398

(22) Filed: Apr. 1, 2022

(51) Int. Cl. H01H 47/00; G08B 17/10; H01R 24/76

(52) U.S. Cl. CPC H01H 47/005; G08B 17/10; H01R 24/76

(57) ABSTRACT

The present disclosure provides a safety power relay apparatus with an integrated smoke sensor. The relay is configured to receive a power supply of an appliances and provide a relay connection to a mains AC power source, but to shut off this connection in the event that smoke particles are detected by the smoke sensor. The control circuitry and the relay switch itself are contained in an insulated housing with a set of controls for resetting the device once the issue has been resolved.

### FIELD OF INVENTION

The present invention relates generally to a power relay for an electrical appliance. More specifically, the present invention relates to a power relay for connecting an appliance to an AC power source, the relay having an integrated smoke detector for shutting off power to the appliance when smoke is detected.

### BACKGROUND

A known occurrence when using electrical appliances, in particular cooking appliances, is for fires to develop when the appliance is left unattended. Other appliances also lead this risk due to the occurrence of electrical fires caused by surges in voltage from the mains AC power supply or short circuits in the appliances themselves.

If left for extended periods of time, the power supply to the appliance being left on can cause the fire to continue for a greater duration or even to worsen and cause far greater damage than had the appliance been turned off.

There do exist appliances with built in shut-off switches for preventing such occurrences in the event of a power surge, but many appliances do not, and it is not safe for an average individual to attempt to modify their appliances to have this capability. Furthermore, in the case of heated appliances being the cause of the problem, conventional automatic shut-off switch circuits cannot detect the problem.

There is a need for a device that can integrate the functionality of shutting off power into a variety of appliances, and which is triggered by the detection of the fire itself, rather than relying on power fluctuations. It is within this context that the present invention is provided.

### SUMMARY

The present disclosure provides a safety power relay apparatus with an integrated smoke sensor. The relay is configured to receive a power supply of an appliances and provide a relay connection to a mains AC power source, but to shut off this connection in the event that smoke particles are detected by the smoke sensor. The control circuitry and the relay switch itself are contained in an insulated housing with a set of controls for resetting the device once the issue has been resolved.

Thus, according to one aspect of the present disclosure there is provided a power relay apparatus, the apparatus comprising: a power socket for receiving a power supply of an appliance; a power supply configured for connection to an AC power source; a protective housing comprising a set of controls on an exterior surface, the set of controls comprising at least a reset control; a relay switch disposed inside the protective housing and which is arranged in series between the power socket and the power supply, the relay switch being configured to move between a first configuration where electrical power is free to flow from the power supply to the power socket and a second configuration where the electrical power from the power supply is shut off from the power socket; and a smoke sensor having a wired connection to the housing.

The apparatus further comprises a control board disposed within the housing and coupled to the controls on the housing, the relay switch, and the smoke sensor, the control board being configured to cause the relay switch to move from the first configuration to the second configuration in response to a detection of smoke from the smoke sensor, and being further configured to move the relay switch from the second configuration to the first configuration in response to an actuation of the reset control.

In some embodiments, the apparatus further comprises a light element on the housing exterior, and wherein the control board is configured to turn the light element on in response to a detection of smoke from the smoke sensor. The control board may be configured to turn the light element off in response to an actuation of the reset control.

In some embodiments, the apparatus further comprises a speaker disposed within the housing, and wherein the control board is further configured to sound an alarm noise through the speaker in response to a detection of smoke from the smoke sensor.

The set of controls may in such cases further comprise a silence control, the control board being configured to cease the alarm noise in response to an actuation of the silence control. The control board may also be configured to cease the alarm sound in response to an actuation of the reset control.

In some embodiments, the power socket is detachable and can be replaced with different types of sockets for receiving different plug types. In other embodiments a single power socket is configured to receive multiple different types of plugs.

In some embodiments, the smoke sensor is a dust sensor.

### BRIEF DESCRIPTION OF THE DRAWINGS

Various embodiments of the invention are disclosed in the following detailed description and accompanying drawings.

FIG. 1 illustrates a components view of an example configuration of a safety relay device according to the present disclosure.

FIG. 2 illustrates an isometric view of the example safety relay device installed between an appliance and an AC power supply.

Common reference numerals are used throughout the figures and the detailed description to indicate like elements. One skilled in the art will readily recognize that the above figures are examples and that other architectures, modes of operation, orders of operation, and elements/functions can be provided and implemented without departing from the characteristics and features of the invention, as set forth in the claims.

### DETAILED DESCRIPTION AND PREFERRED EMBODIMENT

The following is a detailed description of exemplary embodiments to illustrate the principles of the invention. The embodiments are provided to illustrate aspects of the invention, but the invention is not limited to any embodiment. The scope of the invention encompasses numerous alternatives, modifications and equivalent; it is limited only by the claims.

Numerous specific details are set forth in the following description in order to provide a thorough understanding of the invention. However, the invention may be practiced according to the claims without some or all of these specific details. For the purpose of clarity, technical material that is known in the technical fields related to the invention has not been described in detail so that the invention is not unnecessarily obscured.

The terminology used herein is for the purpose of describing particular embodiments only and is not intended to be limiting of the invention. As used herein, the term “and/or” includes any combinations of one or more of the associated listed items. As used herein, the singular forms “a,” “an,” and “the” are intended to include the plural forms as well as the singular forms, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

In the context of the present description, the expression “system” or “detector” includes all types of devices used for detecting the presence of an unwanted or undesirable condition, such as the presence of smoke in a given room, or the presence of carbon monoxide, and the like. Moreover, although the present invention was primarily designed for detecting the presence of smoke in a given room environment, and to be used with household appliances, it may be used in other types of environments, and with other kinds of items, or for other usages requiring a cut-off of a power supply of a given voltage from a given electrical device, as apparent to a person skilled in the art. For this reason, the expressions “smoke”, “detector”, “home”, “household”, “appliance”, etc. should not be taken as to limit the scope of the present invention and include all other kinds of usages or items with which the present invention may be used and could be useful.

Moreover, in the context of the present description, the expressions “system”, “detector”, “cord”, “device”, “assembly”, “apparatus”, “equipment” and “unit”, as well as any other equivalent expressions and/or compound words thereof, may be used interchangeably. The same applies for any other mutually equivalent expressions, such as “detecting”, “monitoring” and “identifying”, for example, as well as “smoke” and “undesirable substance”, as apparent to a person skilled in the art.

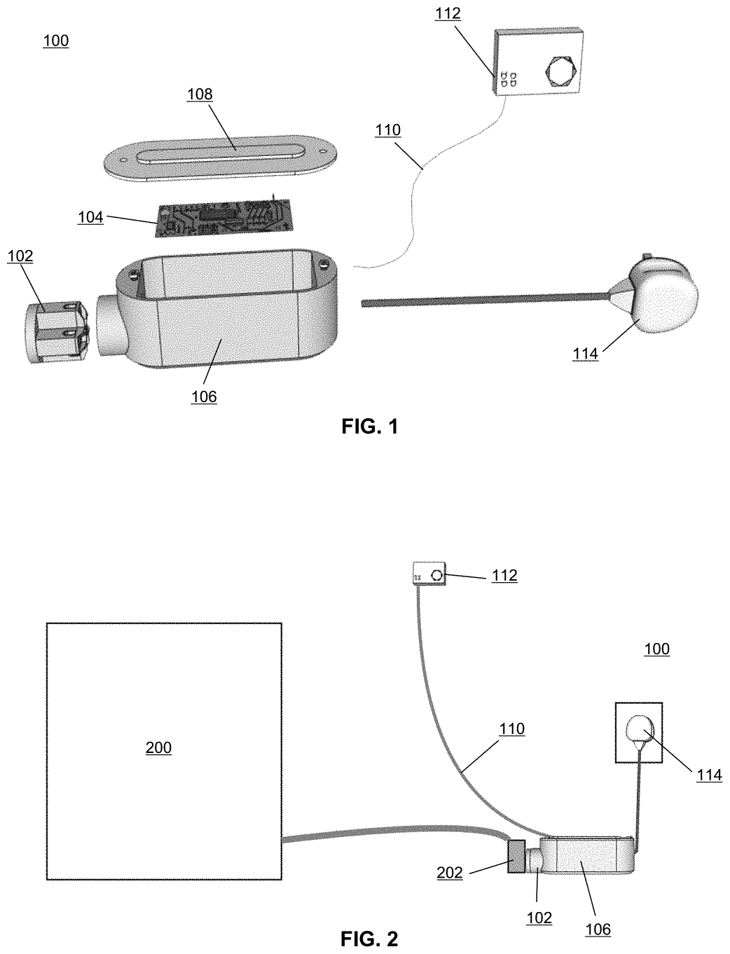

Referring to FIG. 1, a components view of an example configuration of a safety relay device 100 according to the present disclosure is shown.

As can be seen, the device comprises a socket 102 for receiving a power supply of an appliance. In the present example the socket 102 is configured to receive a three point plug, however it should be noted that various types of sockets can be used to accommodate any number of plug types. Indeed, the socket may be detachable and interchangeable with different types of sockets.

The socket 102 connects to a control board 104 which is protected inside an insulated housing 106 with a lid 108. In the present example the relay and power shut-off switch are part of the control board itself but in other examples they may be separate and coupled together by wires etc.

Also connected to the control board 104 is a wired connection 110 to a smoke sensor 112 such as a dust sensor or other suitable type of device capable of detecting smoke particles in a home environment. The wired connection 110 allows the smoke sensor 112 to be placed at a suitable location for detecting the presence of smoke form an appliance, for example the sensor 112 may be adhered to a wall above an appliance, while the housing 106 is placed between the appliance power supply and a power outlet as shown in FIG. 2.

A power supply 114 for the device extends from the opposing side of the housing 106 for drawing power from an AC power outlet, and connects to the control board 104.

The power socket 102, the relay switch of the control board, and the power supply of the device 114 are connected in series, and the control board 104 is configured to cause the relay switch to move from a first configuration where power is supplied to the appliance to a second configuration where power to the appliance is shut off in response to a detection of smoke from the smoke sensor.

A reset control in the form of a switch, button, or dial (not shown) will be disposed on the housing exterior, and the control board will be further configured to move the relay switch from the second configuration to the first configuration, and reset the rest of the device so that the smoke sensor starts taking readings again, in response to an actuation of the reset control.

In some examples the device 100 comprises a light element such as an LED on the housing exterior and the control board 104 is configured to turn the light element on in response to a detection of smoke from the smoke sensor and off again in response to an actuation of the reset control.

The device 100 can also comprise a speaker within the housing 106. In such cases, the control board is configured to sound an alarm noise through the speaker in response to a detection of smoke from the smoke sensor to warn a user that a fire may be starting in the vicinity of the connected appliance. A silence control may also be provided on the exterior of the housing for such cases, with the control board being configured to cease the alarm noise in response to an actuation of the silence control.

Referring to FIG. 2, the example safety relay device 100 is shown installed between an appliance 200, with the power supply of the appliance 202 being plugged into the socket 102, and a mains AC power supply.

As can be seen, the housing of the device 106 rests on or near the floor out of the way, while the sensor 112 is positioned in a place where it is most likely to detect smoke from a fire caused by the appliance 200. The wired connection 1110 allows for a reliable transmission of signal readings form the sensor 112 to the control board, while also allowing for the most convenient placement of both components.

Unless otherwise defined, all terms (including technical terms) used herein have the same meaning as commonly understood by one having ordinary skill in the art to which this invention belongs. It will be further understood that terms, such as those defined in commonly used dictionaries, should be interpreted as having a meaning that is consistent with their meaning in the context of the relevant art and the present disclosure and will not be interpreted in an idealized or overly formal sense unless expressly so defined herein.

The disclosed embodiments are illustrative, not restrictive. While specific configurations of the safety relay device have been described in a specific manner referring to the illustrated embodiments, it is understood that the present invention can be applied to a wide variety of solutions which fit within the scope and spirit of the claims. There are many alternative ways of implementing the invention.

It is to be understood that the embodiments of the invention herein described are merely illustrative of the application of the principles of the invention. Reference herein to details of the illustrated embodiments is not intended to limit the scope of the claims, which themselves recite those features regarded as essential to the invention.

What is claimed is:

1. A power relay apparatus, the apparatus comprising:
a power socket for receiving a power supply of an appliance;
a power supply configured for connection to an AC power source;
a protective housing comprising a set of controls on an exterior surface, the set of controls comprising at least a reset control;
a relay switch disposed inside the protective housing and which is arranged in series between the power socket and the power supply, the relay switch being configured to move between a first configuration where electrical power is free to flow from the power supply to the power socket and a second configuration where the electrical power from the power supply is shut off from the power socket;
a smoke sensor having a wired connection to the housing; and
a control board disposed within the housing and coupled to the controls on the housing, the relay switch, and the smoke sensor, the control board being configured to cause the relay switch to move from the first configuration to the second configuration in response to a detection of smoke from the smoke sensor, and being further configured to move the relay switch from the second configuration to the first configuration in response to an actuation of the reset control.

2. A power relay apparatus according to claim 1, wherein the apparatus further comprises a light element on the housing exterior, and wherein the control board is configured to turn the light element on in response to a detection of smoke from the smoke sensor.

3. A power relay apparatus according to claim 2, wherein the control board is configured to turn the light element off in response to an actuation of the reset control.

4. A power relay apparatus according to claim 1, wherein the apparatus further comprises a speaker disposed within the housing, and wherein the control board is further configured to sound an alarm noise through the speaker in response to a detection of smoke from the smoke sensor.

5. A power relay apparatus according to claim 4, wherein the set of controls further comprises a silence control, and wherein the control board is configured to cease the alarm noise in response to an actuation of the silence control.

6. A power relay apparatus according to claim 4, wherein the control board is configured to cease the alarm sound in response to an actuation of the reset control.

7. A power relay apparatus according to claim 1, wherein the power socket is detachable and can be replaced with different types of sockets for receiving different plug types.

8. A power relay apparatus according to claim 1, wherein the power socket is configured to receive multiple different types of plugs.

9. A power relay apparatus according to claim 1, wherein the smoke sensor is a dust sensor.
